(19) United States
(12) Patent Application Publication
(10) Pub. No.: US 2014/0036919 A1
(43) Pub. Date: Feb. 6, 2014

(54) Forward Progress Assurance and Quality of Service Enhancement in a Packet Transferring System

(71) Applicant: Futurewei Technologies, Inc., Plano, TX (US)

(72) Inventors: Iulin Lih, San Jose, CA (US); Hongbo Shi, Xian (CN); Chenghong He, Shenzhen (CN); Naxin Zhang, Singapore (SG)

(73) Assignee: Futurewei Technologies, Inc., Plano, TX (US)

(21) Appl. No.: 13/955,405

(22) Filed: Jul. 31, 2013

Related U.S. Application Data
(60) Provisional application No. 61/677,654, filed on Jul. 31, 2012.

(51) Int. Cl. H04L 12/725

(52) U.S. Cl. CPC H04L 45/302
USPC 370/392

(57) ABSTRACT

A method comprising detecting at least one Quality of Service (QoS) requirement is met that indicates a very important packet (VIP) is outstanding from a source node in a multi-hop network comprising multiple nodes, sending an initiation message to an adjacent node in response to the detection that may activate a protocol in which a reserved channel is activated, and receiving the VIP via the reserved channel. Also, a method comprising receiving an initiation message from an adjacent node in a multi-hop network that comprises information identifying the VIP comprising a source node, a destination node, a packet type, wherein the initiation message activates a protocol in which a reserved channel is activated, searching for the VIP identified by the initiation message, and forwarding the VIP promptly if present via the reserved channel or forwarding an initiation message to adjacent nodes closer to the source node.

### CROSS-REFERENCE TO RELATED APPLICATIONS

The present application claims priority to U.S. Provisional Patent Application No. 61/677,654 filed Jul. 31, 2012 by Yolin Lih, et al. and entitled “Forward Progress Assurance and Quality of Service Enhancement in a Packet Transferring System,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Packet transferring systems may be utilized to share information among multiple nodes, in which a node may be any electronic component that communicates with another electronic component in a networked system. For example, a node may be a memory device or processor in a computing system (e.g., a computer). The computing system may have a plurality of nodes that need to be able to communicate with one another. A node may employ data buffers to store incoming packets temporarily until they can be processed. Packets may be forwarded from one node to another across physical links, which may be divided into virtual channels. However, throughput and link utilization may be drastically reduced if one or more of the nodes are oversubscribed, and its packet queues back up and consume a large fraction of the available buffers. The overall quality of service (QoS) may be degraded due to high latency during data transmission. Also, forward progress of packets through the system may be hindered due to backed up packet queues at one or more nodes. The problem may proliferate through the system as packets fill up the queues of additional nodes waiting for packets held up at the oversubscribed nodes, for example, due to data dependencies and interdependencies of tasks.

### SUMMARY

In one embodiment, the disclosure includes a method comprising detecting at least one QoS requirement is met, wherein the QoS requirement indicates an expected packet from a source node in a multi-hop network comprising multiple nodes is outstanding, and, wherein the expected packet is designated as a very important packet (VIP), sending a first message via a communication channel to an adjacent node in response to the detecting, wherein the communication channel is divided into a plurality of virtual channels, wherein at least one of the plurality of virtual channels is a reserved virtual channel (VIP channel) that is activated when a VIP protocol is activated, wherein the VIP protocol is activated in response to the first message, and receiving the VIP via the VIP channel.

In another embodiment, the disclosure includes a method comprising receiving a VIP protocol initiation message from an adjacent node in a multi-hop network comprising multiple nodes via a communication channel, wherein the VIP initiation message comprises information identifying a VIP comprising a source node, a destination node, a packet type, wherein the VIP protocol initiation message activates a VIP protocol, wherein the communication channel is divided into a plurality of virtual channels, and wherein at least one of the plurality of virtual channels is a destination VIP channel that is activated when the VIP protocol is activated, searching for the VIP identified by the VIP protocol initiation message, and forwarding the VIP promptly if present via the VIP channel.

In yet another embodiment, the disclosure includes an apparatus comprising a buffer, a processor coupled to the buffer and configured to monitor the buffer and detect if at least one QoS requirement is met, and wherein the QoS requirement indicates an expected VIP from a source node in a multi-hop network comprising multiple nodes is outstanding, a transmitter coupled to the processor and configured to send a VIP initiation message via a communication channel to an adjacent node in response to the detection, wherein the communication channel is divided into a plurality of virtual channels, wherein at least one of the plurality of virtual channels is a reserved virtual channel (VIP channel) that is activated when a VIP protocol is activated, wherein the VIP protocol is activated in response to the VIP initiation message, and a receiver coupled to the processor, wherein the receiver is configured to receive the VIP via the VIP channel.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic of an interconnected network system embodiment.

FIG. 2 illustrates an embodiment of a memory system.

FIG. 3 illustrates an embodiment of a communication link between two nodes with a reserved transfer channel.

FIG. 4 illustrates an embodiment of states of a VIP channel protocol.

FIG. 5 is a flowchart of an embodiment of a forward progress assurance and/or QoS enhancement method.

FIG. 6 is a flowchart of an embodiment of a forward progress assurance and/or QoS enhancement method.

FIG. 7 is a schematic diagram of a packet transferring system.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

One model for packet transfer relies on overly-conservative, pre-allocated buffers and/or bandwidth in order to avoid system forward progress issues like deadlock, livelock, and/or starvation. However, this model may be inefficient by requiring more system resources and consuming more power than necessary to provide this forward progress assurance. Thus, there may be a need to provide a more efficient means of delivering outstanding packets to destination nodes for enhancing QoS and assuring forward progress.

Disclosed herein are methods and apparatuses that provide enhanced QoS and/or forward progress assurance. In order to foster efficiency in data buffers, a packet transferring system may be enhanced by allowing an interconnected network to reserve transfer channel bandwidth between adjacent nodes to alleviate QoS and/or forward progress issues. A node may activate a protocol that may activate the reserved transfer channel with adjacent nodes within possible routing paths by sending a protocol message upon detecting an outstanding packet that may lead to QoS and/or forward progress issues in the interconnected network. QoS and/or forward progress issues may be detected by such events as: receiving a barrier transaction the VIP will satisfy, sending the barrier transaction, receiving a packet of a sequential operation out of order, receiving more than a threshold number of packets of a VIP's packet type, and exceeding a time limit for receiving the VIP. The protocol message may identify an outstanding packet by a source node, destination node, and/or a packet type. The reserved transfer channels may only require enough bandwidth to forward a single packet and may remain inactive until the protocol is activated. Adjacent nodes may search their respective buffers upon receipt of the protocol message, and if the outstanding packet is present, the adjacent nodes may promptly forward the outstanding packet. If the outstanding packet is not present, the adjacent nodes may forward a protocol message to adjacent nodes on possible routing paths to the source node and reserve sufficient resources to receive the outstanding packet. While the protocol is activated, adjacent nodes may refrain from forwarding or may reject receipt of packets that could prevent the outstanding packet from reaching its destination. Rejected packets may be resent upon deactivation of the protocol. Additionally, a node that initiates the protocol may potentially be the only node that deactivates the protocol. The reserved transfer channel may improve packet transfer performance by, for example, accommodating uneven traffic distributions or preventing deadlocks.

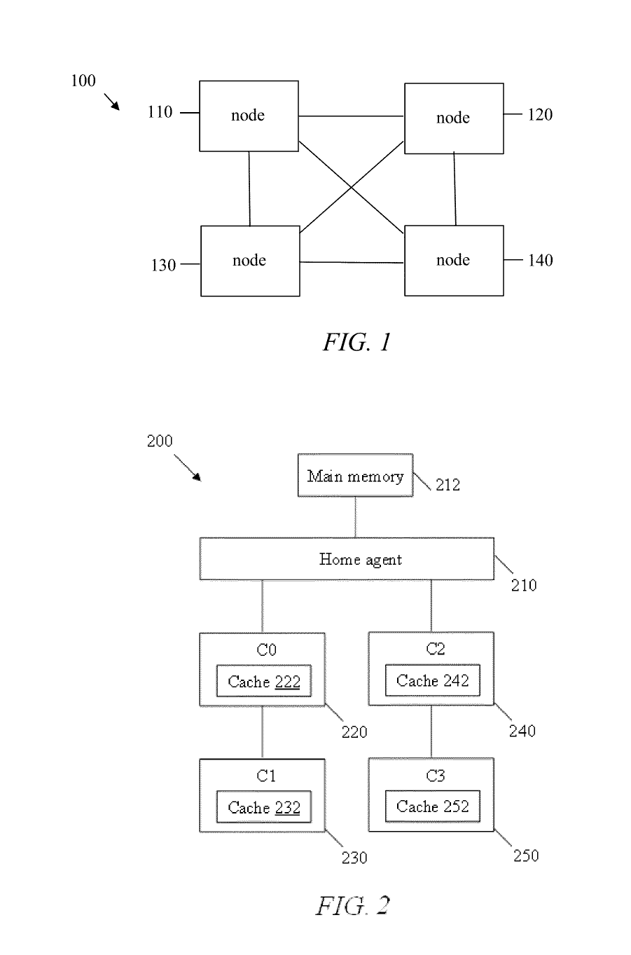

FIG. 1 illustrates an embodiment of an interconnected network system 100. The system 100 may comprise a plurality of nodes, such as node 110, node 120, node 130, and node 140. As illustrative examples, a node may be implemented as a distinct electronic component in a system on a chip (SoC), or a node may be a single chip in a plurality of chips such as in a motherboard for a computer system. That is, the nodes may be located in different chips or within components on the same chip for inter-chip or intra-chip communication, respectively. Although only four nodes are shown for illustrative purposes, any number of nodes may be used in the system. The system 100 is shown as a full mesh for purposes of illustration; however, the reserved transfer channel schemes disclosed herein are not limited to any particular system topology or interconnection. For example, the nodes may be organized as a ring, or any other structure with the nodes arranged in any order.

In system 100, nodes 110-140 are interconnected as a full mesh such that each node may communicate directly with any other node in the system with a single hop. A node may have bidirectional communication capability as it may both transmit and receive packets from other nodes. A transmitting node and a receiving node, which may be referred to hereafter as a transmitter and a receiver, respectively, may each use data buffers to store packets temporarily. For example, node 110 may be a transmitter with a buffer, which holds packets that are to be sent to another node via a transfer channel (e.g. a virtual channel). Virtual channels may be utilized to forward packets from one buffer at a transmitting node to another buffer at a receiving node. A virtual channel may refer to a physical link between nodes, in which the bandwidth is divided into logical sub-channels. Node 110 may forward these packets from the buffer to node 120, which may be the receiver. The packets may subsequently be stored in a buffer at node 120 until they are processed.

In an embodiment, system 100 may be implemented to forward packets of a cache coherence transaction in a cache memory system. Cache coherence transactions may help ensure that changes in shared data or instruction are propagated throughout the system in a timely fashion. For example, a cache coherence transaction may enable communication between an L1 cache and an L2 cache in order to update and maintain consistency in cache contents. When a processor reads or writes a location in main memory, the processor first checks to see if a copy of the data already resides in an L1 cache memory. When present, the processor is directed to the L1 cache memory rather than the slower main memory. For cache to be effective, a processor needs to continually access the L1 cache rather than main memory. Unfortunately, the size of the L1 cache is typically smaller and limited to storing a smaller subset of the data within the main memory. The size limitation may inherently limit the “hit” rate within the L1 cache. A “hit” occurs when the L1 cache holds a valid copy of the data requested by the processor, while a “miss” occurs when the L1 cache does not hold a valid copy of the requested data. When a “miss” occurs within the L1 cache, the processor may subsequently access the slower main memory. Thus, it is possible to have many copies of any one instruction or data: one copy in the main memory and one in each of the L1 cache memories. In this case, when one copy of data or instruction is changed, the other copies should also be changed to maintain coherence. When the system 100 writes a block of data to an L1 cache, it may need to write that block of data back to the main memory at some point. The timing of this write may be controlled by a write policy, which may be a write-through policy or write-back policy.

A packet of the cache coherence transaction may be classified according to its packet type (e.g. a data packet or a control packet). Data packets may contain the data relevant to a node or process such as a payload, while control packets contain information needed for control of a node or process. Additionally, different data and control packets may be divided by priority. Control packets that initiate a transaction may be given a lower priority than control packets that finish a transaction. In cache coherence transactions, higher priority may be given to a packet that is about to finish a transaction while a packet that is starting the transaction may be assigned a lower priority. Packets for intermediate steps of the transaction may correspond to intermediate priority levels. Transmitter buffers may be susceptible to head-of-line (HOL) blocking, which involves a stuck packet at the head of a transmission queue. This behavior prevents transmission of subsequent packets until the blocked packet is forwarded, which may result in a forward progress problem for system 100. This disclosure is explained in the context of cache hierarchies for illustration purposes only; however, the reserved transfer channel scheme could be implemented in any packet transfer system.

FIG. 2 illustrates an embodiment of a memory system 200, which a disclosed forward progress assurance and QoS enhancement method may be implemented. Memory system 200 may be part of a multi-processor computer system with a main memory shared by all processors and a separate cache memory for each of the processors or processing cores. The processors, main memory, and cache memories may be interconnected in the form of an interconnected network, which may be similar to system 100 of FIG. 1. As shown in FIG. 2, memory system 200 may comprise a home agent (HA) 210 and a plurality of cache agents (CAs), including a CA 220 (also denoted as C0), a CA 230 (also denoted as C1), a CA 240 (also denoted as C2), and a CA 250 (also denoted as C3). The HA 210 may comprise a main memory 212 or include a memory controller that is able to access the main memory 212. Each of the CAs 220, 230, 240, and 250 may comprise or have access to each of L1 cache memories (cache) 222, 232, 242, and 252. It should be understood that the memory system 200 may function in concert with other components of the computer system, such as multi-core processor, input/output (I/O) device, etc.

Memory system 200 may implement a coherence protocol to reduce latency and performance bottlenecks caused by frequent access to main memory 212. A cache memory (e.g. cache 222, 232, 242, and/or 252) may typically comprise a plurality of cache lines, which serve as basic units or blocks of data access including read and write accesses. A cache line may comprise data as well as a state. For example, there may be two flag bits per cache line or cache row entry: a valid bit and a dirty bit. The valid bit indicates whether the cache line is valid, and the dirty bit indicates whether the cache line has been changed since it was last read from a main memory 212. If the cache line has been unchanged since it was last read from a main memory 212, the cache line is “clean”; otherwise, if a processor has written new data to the cache line and the new data has not yet made it all the way to a main memory 212, the cache line is “dirty”. When a state of a cache line in a cache is changed (e.g., data in the cache line needs to be evicted or replaced by new data) by a CA (e.g. CAs 220, 230, 240, and/or 250), the updated data may need to be written back to the main memory 212 by a HA 210.

In a coherence protocol, non-snoop messages including write-backs may be treated as special requests. A write-back message (sometimes referred to in short as write-back) may refer to a message from a CA (e.g. CAs 220, 230, 240, and/or 250) to a HA 210 to update a cache line including data and cache line state (e.g., due to an internal event). Considering the difference in message classes, the write-back messages may be classified herein as non-snoop messages (note that a non-snoop message herein cannot be a cache line request). A cache line request may refer to a message from a CA (e.g. CA 220, 230, 240, or 250) to another memory agent (e.g. HA 210 or another CA), due to an internal event. For example, the cache line request may be a read request or a write request from the CA to the other memory agent, responding to a read or write miss in a cache of the CA, to ask for cache line data and/or permission to read or write. HA 210 may keep a directory of all cache lines in the caches, thus HA 210 may be aware of any cache(s) that has checked out data from the corresponding memory address. Accordingly, upon receiving the write request, the HA 210 may send a snoop request (sometimes referred to simply as a snoop) to the CA 230 (also any other CA that has checked out the data), wherein a copy of the data may be stored.

One of the properties is in the order in which the non-snoop messages are handled with respect to other messages. To comply with the principle of cache coherence, different requests should be processed in different orders. For example, if a cache line request following a write-back has the same target cache line address and same sender, they may need to behave as if the delivery ordering is preserved. Otherwise, the cache line request may have priority over the write-back, since the cache line request may reduce the response latency of the request. A commonly seen solution to preserve the cache line request to write-back ordering is to use the same resources, such as a routing channel, for them and to enforce the ordering for messages within this channel if they have the same sender and target address. To simplify the implementation, sometimes the ordering may be enforced tighter than necessary.

The above solution may lead to the issue of deadlock in memory system 200. Suppose, for example, that a cache line request is first sent from a CA (e.g. CA 220, 230, 240, or 250) to a HA 210, and a volunteer write-back is then sent from the same CA to the HA 210. For example, a volunteer write-back message may be sent from the CA to the HA 210 as part of a replacement notice, without responding to any third-party cache line request. According to a delivery order, the HA 210 should process the cache line request first and then the write-back. Further, suppose that the cache line request requires the result of the write-back before the cache line request can be processed by the HA. However, if the HA has limited resources (e.g., memory space and/or bandwidth), the HA cannot process the write-back to get the required result, thus leading to a deadlock.

To avoid deadlock, some coherence protocols may pre-allocate HA 210 with a large amount of resources, such as a large buffer size and/or a large bandwidth, such that all write-back messages received by HA 210 will be able to be processed. For instance, if HA 210 has been read 100 times previously, there is a maximum of 100 write-backs to be received by HA 210. In this case, HA 210 can be pre-allocated with enough resources to simultaneously process 200 operations (including 100 cache line requests and 100 write-backs). Although the deadlock can be avoided using this solution, the solution may require a large amount of resources (e.g., buffer size and/or bandwidth), which may raise system cost. Thus, it is desirable to provide a means of resolving issues such as deadlock that degrade QoS and negatively impact forward progress without raising system cost or complexity.

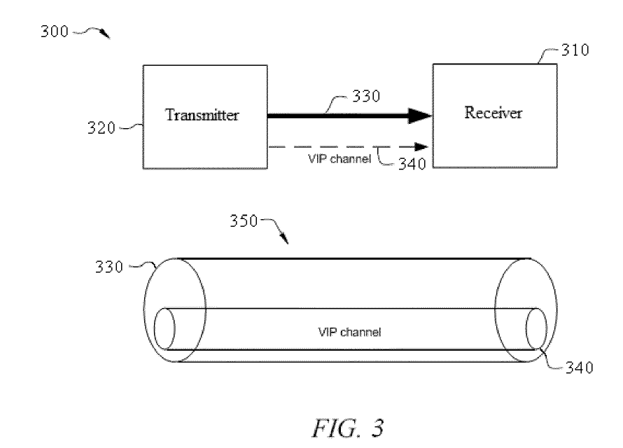

FIG. 3 illustrates an embodiment of a communication link between two nodes with a reserved transfer channel (VIP channel) 300. Communication link 300 may comprise a receiver 310 coupled to a transmitter 320 via an upstream channel 330 and a VIP channel 340. Receiver 310 and transmitter 320 may be nodes in an interconnected network, which may be similar to HA 210 and CA 220 of FIG. 2, respectively. Upstream channel 330 may comprise a plurality of virtual channels that transmitter 320 utilizes to forward packets to receiver 310. Transmitter 320 may save packet data in a buffer to forward to a buffer in receiver 310 via upstream channel 330. Receiver 310 and transmitter 320 may also use flow control handshaking to regulate packet flows so that receiver 310 has enough buffer space to accept a data packet and transmitter 320 is ready to transmit the data packet. As illustrated in FIG. 3, VIP channel 340 may be implemented as a virtual channel that may be a logical partition of a physical link 350 between transmitter 310 and receiver 320. That is, the bandwidth of physical link 350 may be divided into VIP channel 340 and upstream channel 330. In communication link 300, transmitter 320 may refrain from sending packets via VIP channel 340 until a VIP protocol is initiated. The VIP channel 340 may require only one packet's worth of bandwidth in communication link 300 to provide an efficient means of delivering outstanding packets to the node initiating the VIP protocol.

A VIP protocol may be initiated when a node in an interconnected network detects possible QoS or forward progress issues. One example of a QoS or forward progress issue may be a node receiving a packet comprising a transaction message out of sequence, such as the deadlock scenario of FIG. 2. Another indication of a QoS or forward progress issue may be a node receiving a barrier construct preventing a packet from proceeding until related packets have arrived, while at least one related packet is outstanding. Furthermore, the VIP protocol may also be initiated by a transmitter in the interconnected network. For example, the transmitter may initiate the VIP protocol after a period of time has expired when expecting a response to a message sent to another node in the interconnected network. The node may initiate the VIP protocol to locate the outstanding packet (VIP packet) creating the possible QoS or forward progress issue in order to mitigate its impact on the interconnected system. An initiating node may send a VIP initiation message to any adjacent node within a possible routing path between the initiating node and the source node of the VIP packet. In an embodiment, the initiating node may send the VIP initiation message to the adjacent nodes via flow control messages that may not require buffer space to be received. The VIP initiation message may comprise information identifying the VIP packet by such as the packet's source, destination, and packet type.

Upon receiving a VIP initiation message, the VIP channel 340 between the node sending the VIP initiation message and adjacent node may be activated. The adjacent node receiving the VIP initiation message may check to determine whether the VIP packet is present in its buffers. If the VIP packet is present, the adjacent node may forward the VIP packet to the initiating node via the VIP channel 340. If the VIP packet is not present, the adjacent node may send a VIP initiation message to any nodes adjacent to it within a possible routing path between the adjacent node and the source node. This process may be repeated until the VIP packet is present in a node receiving a VIP initiation message. Thus, by cascading VIP initiation messages along all possible routing paths between the initiating node and the source node, the VIP packet may be located. The VIP packet may be forwarded through a chain of VIP channels between the node storing the VIP packet and the initiating node. In an embodiment, the chain of VIP channels may remain active until the initiating node receives the VIP packet and sends a VIP termination message to any adjacent node within a possible routing path between the initiating node and the source node.

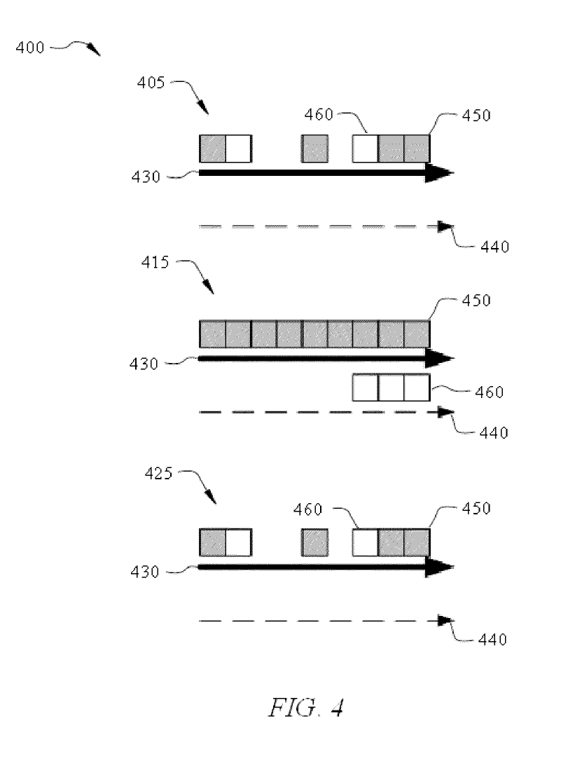

FIG. 4 illustrates an embodiment of states of a VIP channel protocol 400. At state 405, a VIP initiation message has not been received by a transmitter (e.g. transmitter 320 of FIG. 3) so a VIP channel 440, which may be similar to VIP channel 340 of FIG. 3, may not be active. The transmitter may send all packets to an upstream receiver (e.g. receiver 310 of FIG. 3) via upstream channel 430, which may be similar to upstream channel 330 of FIG. 3, while VIP channel 440 is inactive. Therefore, at state 405, packets that may create QoS or forward progress issues in an interconnected system (VIP packets) 460 may be queued for transmission with all other packets (non-VIP packets) 450. The non-VIP packets 450 may prevent the VIP packets 460 from reaching the upstream receiver through HOL blocking. Thus, the VIP packets 460 may remain in the transmitter's buffer until the blocking non-VIP packets can reach the upstream receiver. In an embodiment, packets awaiting the VIP packets 460 may exacerbate the problem by creating HOL blocking a destination node's transmission buffer upstream. As a result, the interconnected network may experience a possible QoS or forward progress issue at state 405.

At state 415, a VIP initiation message signaling the beginning of a VIP channel protocol 400 may have been received by the transmitter from the upstream receiver, and the VIP channel 440 may be activated. The transmitter may check to determine if VIP packets 460 identified in the VIP initiation message are present. If the transmitter determines that VIP packets 460 are present, the transmitter may promptly send the VIP packets 460 to the receiver via the VIP channel 440. The VIP packets 460 may be sent further upstream to the destination node via a VIP channel between the receiver and an upstream receiver if the upstream receiver is not the destination node for the VIP packets 460. If the transmitter determines that VIP packets 460 are not present, the transmitter may reserve buffer space for the VIP packets 460 and continue to monitor for the VIP packets 460. The transmitter may continue to send non-VIP packets 450 to the upstream receiver via the upstream channel 430 at state 415. In an embodiment, the receiver may reject non-VIP packets 450 until a VIP termination message is received and the VIP channel 440 is inactive. Any rejected non-VIP packets 450 may be resent upon receiving the VIP termination message.

At state 425, a VIP termination message signaling the close of the VIP channel protocol 400 may be received by the transmitter from the adjacent receiver, and the VIP channel 440 may become inactive. Similar to state 405, the transmitter may send all packets to the upstream receiver via the upstream channel 430. Any non-VIP packets 450 rejected while the VIP channel protocol 400 was active may be resent to the upstream receiver.

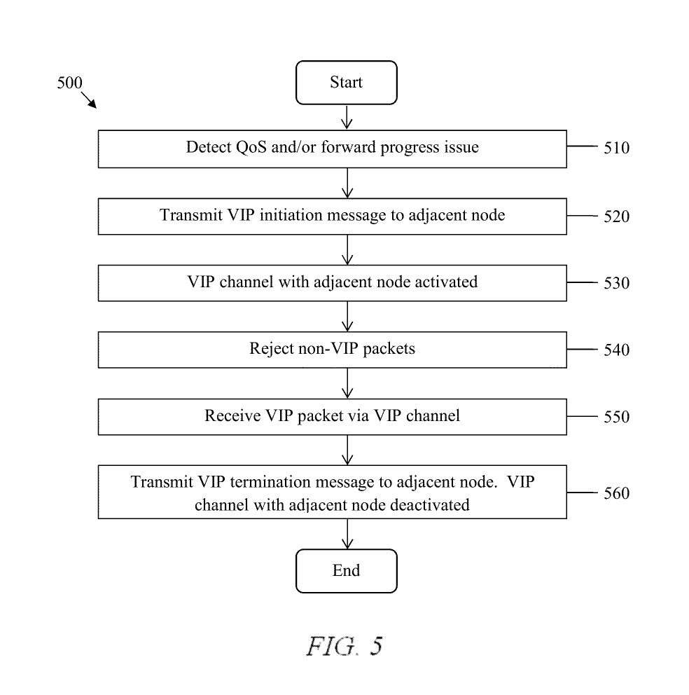

FIG. 5 is a flowchart of an embodiment of a forward progress assurance and/or QoS enhancement method 500. The steps of method 500 may be implemented in either a receiving or transmitting node such as a node in FIG. 1, but will be described in the context of a receiving node. The flowchart begins in block 510, in which a receiving node may detect a QoS and/or forward progress issue in an interconnected network. The QoS or forward progress issue may be detected due to the receipt of a packet comprising a transaction message out of sequence. Also, receiving a barrier construct preventing a packet from proceeding until related packets have arrived while at least one related packet is outstanding may indicate a QoS or forward progress issue. Alternatively, the passage of a specified time while awaiting the arrival of a specific packet may suggest a QoS or forward progress problem in the network. In block 520, the receiver may transmit a VIP initiation message to any adjacent node that is located along a possible routing path to the source of the outstanding packet (VIP packet). One way a VIP initiation message may be sent is through flow control message. The VIP initiation message may signal the commencement of a VIP channel protocol. In an embodiment, the VIP initiation message may comprise information identifying the VIP packet such as the source node, the destination node, and the packet type. A VIP channel between the receiving node and the adjacent nodes receiving the VIP initiation message may become active in block 530. The VIP channel may be a virtual channel reserved for VIP packets while a VIP channel protocol is active. In an embodiment, the VIP channel may be of limited size, such as enough bandwidth to transfer a single packet. Next in block 540, the receiving node may optionally reject any packets that are not the VIP packet. In an embodiment, the receiving node may reject any packets that may consume node resources needed for the VIP packet, such as transfer channel bandwidth and/or buffer space. Any packets that do not conflict with the VIP packet, such as other packet types, may be accepted in this embodiment. In block 550, the VIP packet may arrive at the receiving node via the VIP channel. Finally in block 560, the receiving node may transmit a VIP termination message to the adjacent nodes that the VIP initiation message was sent in block 520. The VIP termination message may signal the ending of the VIP channel protocol. In an embodiment, only the receiving node as the node initiating the VIP channel protocol may end the VIP channel protocol.

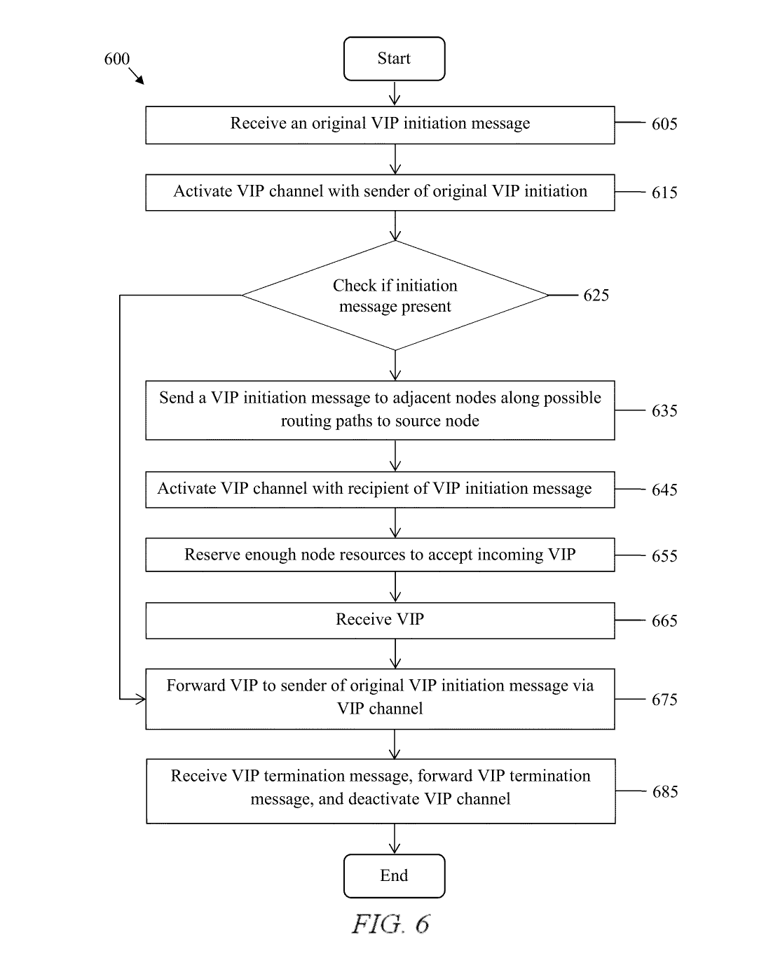

FIG. 6 is a flowchart of an embodiment of a forward progress assurance and/or QoS enhancement method 600. The flowchart begins in block 605 with a node in an interconnected network, such as in FIG. 1, receiving a VIP initiation message. The VIP initiation message may identify a VIP and may be similar to the VIP initiation message in method 500. Also, the VIP initiation message may signify the commencement of a VIP channel protocol. In block 615, a VIP channel may be activated between the node and the node sending the VIP initiation message in block 605. Next in block 625, the node may check to see if the VIP is present in the node's buffers. In an embodiment, any packets that are not the VIP (non-VIPs) the node attempts to send may be rejected by the upstream adjacent node. If the VIP is not present in the node's buffers, the node may send a VIP initiation message to at least one adjacent node located along a possible routing path to the source of the VIP at block 635. Next in block 645, at least one VIP channel may be activated between the node and any adjacent nodes that received a VIP initiation message in block 635. In block 655, the node may reserve buffer space for the VIP and monitor its buffers for the arrival of the VIP via a VIP channel. In block 665, the node may receive the VIP via a VIP channel. The received VIP, or alternatively if the VIP was determined to be present in block 625, the node may promptly forward the sender of the original VIP via a VIP channel in block 675. Next at block 685, the node may receive a VIP termination message from the sender of the original VIP initiation message. The VIP termination message may be received after a destination node receives the VIP packet. Additionally, the VIP termination message may signify the ending of the VIP channel protocol. The destination node may be a node in the network that detected the QoS or forward progress issue, such as the receiving node of method 500 in FIG.5. Also, the destination node may be the node that originated the VIP channel protocol in the network. In an embodiment, the node that originated the VIP channel protocol in the network may be the only node that may end the VIP channel protocol. Furthermore, the node may forward a VIP termination message to any adjacent nodes receiving a VIP initiation message in block 635. Nodes receiving a VIP termination message may also deactivate VIP channels. The node may also resend any non-VIP packets that may have been rejected while the VIP channel protocol was active.

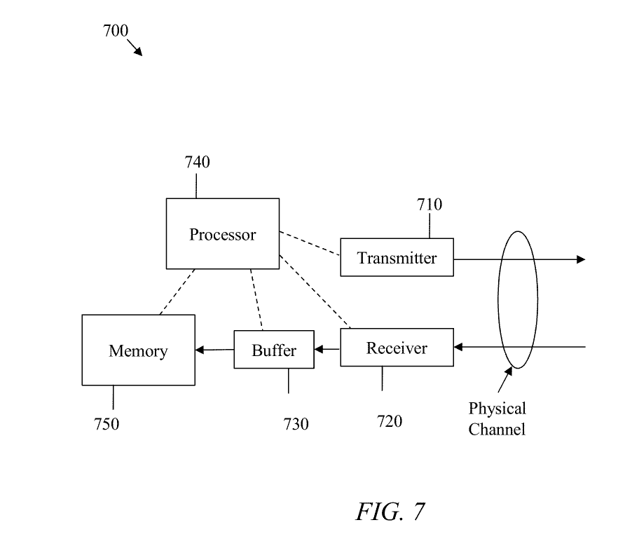

At least some of the features/methods described in the disclosure may be implemented in a network apparatus or electrical component with sufficient processing power, memory/buffer resources, and network throughput to handle the necessary workload placed upon it. For instance, the features/methods of the disclosure may be implemented using hardware, firmware, and/or software installed to run on hardware. FIG. 7 illustrates a schematic diagram of a node 700 suitable for implementing one or more embodiments of the components disclosed herein. The node 700 may comprise a transmitter 710, a receiver 720, a buffer 730, a processor 740, and a memory 750 configured as shown in FIG. 7. Although illustrated as a single processor, the processor 740 may be implemented as one or more central processing unit (CPU) chips, cores (e.g., a multi-core processor), field-programmable gate arrays (FPGAs), application specific integrated circuits (ASICs), and/or digital signal processors (DSPs). The transmitter 710 and receiver 720 may be used to transmit and receive packets, respectively, while the buffer 730 may be employed to store packets temporarily. Packets may be forwarded from the node 700 across a physical channel, which may be divided into a plurality of virtual channels as described previously. At least one of the plurality of virtual channels may be designated as a VIP channel (e.g. VIP channels 340 and/or 440).

The memory 750 may comprise any of secondary storage, read only memory (ROM), and random access memory (RAM). The RAM may be any type of RAM (e.g., static RAM) and may comprise one or more cache memories. Secondary storage is typically comprised of one or more disk drives or tape drives and is used for non-volatile storage of data and as an over-flow data storage device if the RAM is not large enough to hold all working data. Secondary storage may be used to store programs that are loaded into the RAM when such programs are selected for execution. The ROM may be used to store instructions and perhaps data that are read during program execution. The ROM is a non-volatile memory device that typically has a small memory capacity relative to the larger memory capacity of the secondary storage. The RAM is used to store volatile data and perhaps to store instructions. Access to both the ROM and the RAM is typically faster than to the secondary storage.

The node 700 may implement the methods and algorithms described herein, including methods 500 and 600. For example, the processor 740 may control the partitioning of buffer 730 and may keep track of buffer credits. The processor 740 may instruct the transmitter 710 to send packets and may read packets received by receiver 720. Although shown as part of the node 700, the processor 740 may not be part of the node 700. For example, the processor 740 may be communicatively coupled to the node 700.

It is understood that by programming and/or loading executable instructions onto the node 700 in FIG. 7, at least one of the processor 740 and the memory 750 are changed, transforming the system 700 in part into a particular machine or apparatus having the functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term “about” means +/−10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method comprising:
detecting that at least one Quality of Service (QoS) requirement is met, wherein the QoS requirement indicates that an expected packet from a source node in a multi-hop network comprising multiple nodes is outstanding, and, wherein the expected packet is designated as a very important packet (VIP);
sending a first message via a communication channel to an adjacent node in response to the detecting that at least one QoS requirement is met, wherein the communication channel is divided into a plurality of virtual channels, wherein at least one of the plurality of virtual channels is a reserved virtual channel (VIP channel) that is activated when a VIP protocol is activated, and wherein the VIP protocol is activated in response to the first message; and
receiving the VIP via the VIP channel.

2. The method of claim 1, wherein the QoS requirements comprise receiving a barrier transaction the VIP will satisfy, sending the barrier transaction, receiving a packet of a sequential operation out of order, receiving more than a threshold number of packets of a VIP's packet type, and exceeding a time limit for receiving the VIP.

3. The method of claim 2, wherein the first message comprises information identifying the VIP, wherein the information identifying the VIP comprises indications of the source node, a destination node, the packet type, and wherein the adjacent node is located within a plurality of possible routing paths between the source node and the destination node.

4. The method of claim 2, further comprising sending a second message to the adjacent node via the physical channel upon receipt of the VIP, and wherein the VIP protocol is deactivated in response to the second message.

5. The method of claim 3, wherein the first message is sent by a VIP protocol initiating node, and wherein only the destination node may terminate the VIP protocol.

6. The method of claim 3, further comprising rejecting any packets that are non-VIPs while the VIP protocol is active.

7. The method of claim 6, further comprising resending any non-VIPs rejected while the VIP protocol is active.

8. The method of claim 3, wherein the adjacent node promptly forwards the VIP via the VIP channel when the VIP is present in the adjacent node, and wherein the adjacent node refrains from sending non-VIPs while the VIP protocol is active.

9. The method of claim 3, wherein the adjacent node sends a copy of the first message to an adjoining node within a possible routing path between the adjacent node and the source node if the VIP is not present in the adjacent node, wherein the copy of the first message activates at least one downstream VIP channel between the adjacent node and the adjoining node, and wherein the adjacent node promptly forwards the VIP via the VIP channel upon receiving the VIP from the adjoining node via the downstream VIP channel.

10. The method of claim 1, wherein the VIP channel comprises bandwidth for one packet.

11. A method comprising:
receiving a very important packet (VIP) protocol initiation message from an adjacent node in a multi-hop network comprising multiple nodes via a communication channel, wherein the VIP initiation message comprises information identifying a VIP comprising a source node, a destination node, a packet type, wherein the VIP protocol initiation message activates a VIP protocol, wherein the communication channel is divided into a plurality of virtual channels, and wherein at least one of the plurality of virtual channels is a destination reserved virtual channel (VIP channel) that is activated when the VIP protocol is activated;
searching for the VIP identified by the VIP protocol initiation message; and
forwarding the VIP promptly if present via the VIP channel.

12. The method of claim 11, further comprising refraining from sending any packets that are not VIP (non-VIPs) while the VIP protocol is active.

13. The method of claim 11, wherein the adjacent node will reject any non-VIPs sent while the VIP protocol is active.

14. The method of claim 13, further comprising resending any non-VIPs rejected while the VIP protocol is active.

15. The method of claim 11, further comprising receiving a VIP protocol termination message from the adjacent node via the physical channel VIP protocol initiation message, and wherein the VIP protocol is deactivated in response to the VIP protocol termination message.

16. The method of claim 11, further comprising sending a copy of the VIP protocol initiation message to an adjoining node within a possible routing path to the source node if the VIP is not present and wherein the copy of the VIP protocol initiation message activates an intervening VIP channel with the adjoining node.

17. The method of claim 16, further comprising forwarding the VIP promptly via the VIP channel upon receipt.

18. An apparatus comprising:
a buffer;
a processor coupled to the buffer and configured to monitor the buffer and detect when at least one Quality of Service (QoS) requirement is met, wherein the QoS requirement indicates a very important packet (VIP) expected from a source node in a multi-hop network comprising multiple nodes is outstanding;
a transmitter coupled to the processor and configured to send a VIP initiation message via a communication channel to an adjacent node in response to the detection, wherein the communication channel is divided into a plurality of virtual channels, wherein at least one of the plurality of virtual channels is a reserved virtual channel (VIP channel) that is activated when a VIP protocol is activated, wherein the VIP protocol is activated in response to the VIP initiation message; and
a receiver coupled to the processor and configured to receive the VIP via the VIP channel.

19. The apparatus of claim 18, wherein the QoS requirements comprise receiving a barrier transaction the VIP will satisfy, sending the barrier transaction, receiving a packet of a sequential operation out of order, receiving more than a threshold number of packets of a VIP's packet type, and exceeding a time limit for receiving the VIP.

20. The apparatus of claim 18 wherein the processor is further configured to cause the transmitter to send a VIP termination message after the receiver receives the VIP, and wherein the VIP termination message terminates the VIP protocol.
